(19) United States
(12) Patent Application Publication
(10) Pub. No.: US 2004/0051203 A1
(43) Pub. Date: Mar. 18, 2004

(54) Method of producing polytrimethylene terephthalate short fibers

(76) Inventor: Toshihiro Yamada, Ehime (JP)

Correspondence Address: SUGHRUE MION, PLLC, 2100 PENNSYLVANIA AVENUE, N.W., SUITE 800, WASHINGTON, DC, 20037, US

(21) Appl. No.: 10/451,422

(22) PCT Filed: Oct. 23, 2002
(86) PCT No.: PCT/JP02/11000

(30) Foreign Application Priority Data
Oct. 24, 2001 (JP) 2001-326069

(51) Int. Cl. B29C 47/60

(52) U.S. Cl. 264/211.22

(57) ABSTRACT

In production of polytrimethylene terephthalate staple fibers, in a period of time after a polytrimethylene terephthalate polymer is melt spun, and the resultant undrawn tow is taken-up through a taking roll and placed in a can, but before the undrawn tow placed in the can is subjected to a drawing step, the water content of the undrawn tow is maintained at 0.5 to 12% by mass and the temperature of the ambient atmosphere around the undrawn tow is maintained at 35° C. or less.

### TECHNICAL FIELD

The present invention relates to a method of producing polytrimethylene terephthalate staple fibers.

### BACKGROUND ART

The polytrimethylene terephthalate obtained by polycondensing terephthalic acid or a lower alkyl ester of the terephthalic acid, for example, dimethyl terephthalate, with trimethylene glycol (1,3-propanediol) is a polymer having both properties similar to those of polyamides, for example, a low modulus of elasticity (a soft handle), an excellent elastic recovery ratio and easy dyeability, and performances similar to those of polyethylene terephthalate, for example, high light resistance, thermal setting properties, dimensional stability and a low water absorption. Techniques for producing polytrimethylene terephthalate staple fibers utilizing the excellent characteristics thereof have been studied from various standpoints for the purpose of a practical use of the staple fibers in waddings, nonwoven fabrics, spun yarn woven fabrics etc.

On the other hand, in the production of staple fibers of polyesters, for example, polyethylene terephthalate, usually an undrawn filament tow which is produced by a melt-spinning is temporarily stored in a can and is then subjected to a drawing step.

However, when polytrimethylene terephthalate staple fibers are obtained in accordance with this method, a problem that the undrawn polytrimethylene terephthalate filament tow greatly shrinks, while the undrawn filament tow is temporarily stored in the can, occurs.

### DISCLOSURE OF THE INVENTION

An object of the present invention is to provide a method, of producing polytrimethylene terephthalate staple fibers, which enables a change in physical properties of the undrawn filament tow composed of polytrimethylene terephthalate with time to be reduced and polytrimethylene terephthalate staple fibers having uniform quality to be stably produced.

The inventors of the present invention have found that the above-mentioned object can be attained by keeping the undrawn filament tow, produced by a melt-spinning procedure and stored in a can, at a prescribed water content at a prescribed temperature until the tow is fed to the drawing step, to hinder the deterioration in quality of the polytrimethylene terephthalate staple fiber, and the present invention was completed on the basis of the above-mentioned finding.

That is, the method of producing the polytrimethylene terephthalate staple fibers of the present invention with which the object can be achieved is characterized in that during the period of time after a polytrimethylene terephthalate polymer is melt-spun and the resultant undrawn tow is taken up through a taking-up roller and placed in a can, but before the undrawn tow stored in the can is subjected to a drawing step, the water content of the undrawn tow is maintained at 0.5 to 12% by mass, and the temperature of the ambient atmosphere surrounding the undrawn tow is maintained at 35° C. or less.

### BRIEF DESCRIPTION OF DRAWINGS

FIG. 1 illustrates a pressurized air type suction device usable for the method of the present invention.

### BEST MODE FOR CARRYING OUT THE INVENTION

The polymer usable for the method of the present invention comprises, as a principal component, polytrimethylene terephthalate obtained by a polycondensation of terephthalic acid with 1,3-propanediol. In the present invention, the polytrimethylene terephthalate polymer may be a polytrimethylene terephthalate homopolymer or a polytrimethylene terephthalate copolymer as described below. Namely, at least one acid component selected from isophthalic acid, succinic acid, adipic acid, 2,6-naphthalenedicarboxylic acid, 5-sodium sulfoisophthalic acid, and tetrabutylphosphonium 5-sulfoisophthalate; or at least one glycol component selected from 1,4-butanediol, 1,6-hexanediol and cyclohexanedimethanol; or at least one member selected from ε-caprolactone, 4-hydroxybenzoic acid, polyoxyethylene glycol, polytetramethylene glycol, etc. may be copolymerized with the polymer in an amount of 15 molar % or below, preferably 5 molar % or below as long as a deterioration on effects of the present invention occurs. Various kinds of additives, for example delustering agents heat stabilizers, antifoaming agents, orthochromatic agents, antioxidants, ultraviolet absorbers, infrared absorbers, crystal nucleating agents, fluorescent brighteners etc. if necessary, may be copolymerized or mixed in the polymer.

The intrinsic viscosity of the polymer used in the present invention is preferably within the range of 0.5 to 1.8, more preferably within the range of 0.7 to 1.2. If the intrinsic viscosity is less than 0.4, it may be difficult to obtain a sufficient fiber strength because the molecular weight of the polymer is too low. Conversely, if the intrinsic viscosity exceeds 1.8, the spinning may be difficult because the melt viscosity is too high.

In the present invention, the polytrimethylene terephthalate polymer is initially melt-spun through a conventional spinneret. In the process, the melt extrusion temperature (spinning temperature) is preferably within the range of 235 to 285° C., more preferably within the range of 240 to 260° C. If the spinning temperature is higher than 285° C., discoloration or deterioration of strength and elongation due to decomposition of the polymer may readily occur. Conversely, if the spinning temperature is lower than 235° C., it is difficult to obtain fibers having a sufficient strength and elongation.

The polymer melt extruded from the spinneret is taken up by a take-up roller and cooling air, at 20 to 30° C., is preferably blown on the polymer just under the spinneret to solidify the melt extruded polymer. Further, the polymer is solidified into a filament yarn and then water and an oil are preferably applied to the resulting filament yarn. In the process, the amount of water can suitably be regulated to thereby adjust the water content of the undrawn filament tow stored in a can. There is no special limitation on a method for applying the water and the oil to the filament yarn; however, an oiling roller method is preferably applied. The taking-up speed of the filament yarn by the take-up roller is preferably 500 to 2,000 m/min, more preferably 1,000 to 1,500 m/min.

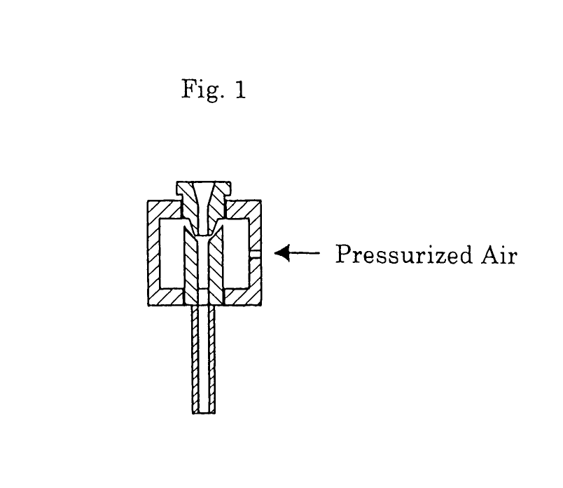

The filament yarn taken up with the take-up roller is subsequently stored as an undrawn tow in the can. In the case where the filament yarn is taken-up by a taking-up roller, and the taken-up filament yarn falls down into a can naturally, if the water content of the filament yarn is too low, the individual filaments may be disordered and a trouble such as winding the filaments around the roller may occur. In this case, the filament yarn taken-up through the taking up roller is preferably passed through a suction apparatus using a pressurized air stream as shown in FIG. 1, to positively cause the filament yarn to fall into the can and be contained therein. In FIG. 1, the undrawn tow (not shown) is sucked downward by the sucking action of the pressurized air stream.

The undrawn tow contained in the can is then temporarily stored and subsequently drawn in a drawing step. During storage, the water content of the undrawn tow within must be maintained in the range of 0.5 to 12% by mass, preferably within the range of 1 to 7% by mass, more preferably within the range of 1 to 4% by mass. When the water content is more than 12% by mass, the individual filaments in the undrawn tow may easily stick each other during storage. When the water content is higher than 12% by weight, water collects in the can in which the filament yarn is stored, the water content of a portion of the undrawn tow located in the bottom part of the can increases and the sticking of the individual filaments with each other may be promoted. Conversely, if the water content of the undrawn tow is lower than 0.5% by mass, single filaments in the undrawn tow are entangled or broken, when the undrawn tow is taking out from the can in the drawing step. As a result, stable drawing is cannot be carried out. There is no special limitation to a method for keeping the water content of the undrawn tow within the above-mentioned range; however, a method for applying a prescribed water content to the filament yarn, in which, for example, in a melt-spinning step, the water content of a filament yarn is adjusted to a desired value by an oiling roller, the resultant filament yarn is contained in a can, and the can is closely sealed, is preferably carried out.

When the undrawn tow is temporarily stored, the atmospheric temperature must be maintained at 35° C. or below, preferably 0 to 30° C., more preferably 0 to 25° C. If the atmospheric temperature is higher than 35° C., there is a fear of shrinking the undrawn tow or causing mutual sticking of the individual filaments.

Furthermore, in the present invention, the shrinkage of the undrawn tow after the passage of 24 hours is preferably 20% or below, more preferably 10% or below. In the drawing step, the undrawn filament yarns taken out from a plurality of cans are usually combined and drawn. The drawing procedure, however, can be stably carried out by controlling the shrinkage in the above-mentioned range, and a drawn filament yarn and staple fibers having a uniform quality can be obtained.

In the present invention, a method which is generally carried out for polyethylene terephthalate fibers can be adopted, as a method for drawing the undrawn tow. The drawn tow can be crimped and further cut into staple fibers by the method which is generally performed for the polyethylene terephthalate fibers.

According to the present invention, the shrinkage of the undrawn tow, which is prepared by a melt-spinning, with time can markedly be reduced. The resulting undrawn tow has an excellent quality without mutual sticking or entanglement of the individual filaments. Therefore, the polytrimethylene terephthalate staple fibers obtained by the production method of the present invention have high quality and are extremely suitable as staple fibers for waddings, nonwoven fabrics or spun yarns.

### EXAMPLES

Examples of the present invention and Comparative Examples will be detailed hereafter; however, these Examples are not to be construed to limit the present invention. Respective measurement items in the Examples were measured according to the following methods.

(1) Intrinsic Viscosity

The intrinsic viscosity was determined at 35° C. by using o-chlorophenol as a solvent.

(2) Water Content of Undrawn Tow

The undrawn tow just after being contained in a can was placed in a hot-air dryer and dried at 110° C. for 1 hour to determine the water content by the following equation water.

Moisture content of undrawn tow=((A₀−A₁)/A₁)×100(%)

wherein, A₀ is the mass of the undrawn tow before drying; and A₁ is the mass of the undrawn tow after drying.

The water content in the undrawn tow was changed by appropriately changing the number of revolutions of an oiling roller installed between a spinneret and a take-up roller.

(3) Atmospheric Temperature

The temperature in a closed room in which the undrawn tow was allowed to stand was taken as the atmospheric temperature.

(4) Elapsed Time

The time passed from the time just after storing the tow in the can to the measurement of the shrinkage of the undrawn tow was taken as the elapsed time.

(5) Shrinkage of Undrawn Tow

The thickness of the undrawn tow was measured after the passage of a prescribed time (the elapsed time) from start of the storing of the undrawn tow in the can, and an increase in the thickness from the thickness of the undrawn tow just after the start storing in the can was calculated as a shrinkage of the undrawn tow.

(6) Surface Conditions of Undrawn Tow

The surface conditions of the undrawn tow were judged by naked eye observation.

3: No sticking and entanglement of individual filaments are found. Good.

2: Slight sticking and entanglement of individual filaments are found.

1: Sticking and entanglement of individual filaments are found.

### Examples 1 to 7 and Comparative Example 1

Polytrimethylene terephthalate chips having an intrinsic viscosity of 0.93 were dried at 130° C. for 5 hours, then melted at 250° C., and the melt was extruded through a spinneret provided with 1,008 spinning holes with a circular section having a diameter of 0.28 mm at an extrusion rate of 660 g/min, and cooling air at 25° C. was blown from the outside to the peripheries of polymer streams to solidify the polymer streams. The resulting filaments were then brought into contact with an oiling roller to impart water and an oil to the filament. The filaments were taken up with a take-up roller at a peripheral speed of the roller of 1,300 m/min and then passed through a pressurized air type suction apparatus (shown in FIG. 1) installed just downstream from the take-up roller and placed, as a undrawn tow, in a can.

The water content and thickness of the undrawn tow placed in the can were immediately measured, and the undrawn tow was then placed in bags and hermetically sealed so as not to allow the water to evaporate. The resultant undrawn tow was stored in rooms at the indoor temperatures shown in Table 1. After the passage of a prescribed time, the undrawn tow was taken out from the bags to measure the thickness. Thereby, the shrinkage of the tow was determined and surface conditions of the undrawn tow were judged by the naked eye observation. Table 1 shows the results of evaluation.

### Comparative Example 2

The shrinkage percentage was determined and the surface conditions of the undrawn tows were simultaneously judged by the naked eye observation in the same manner as in Example 1, except that the water content of the undrawn tow was reduced by regulating the number of revolutions of the oiling roller. Table 1 shows the results of evaluation.

### Comparative Example 3

The shrinkage of the undrawn tow was determined and the surface conditions of the undrawn tow were simultaneously judged by the naked eye observation in the same manner as in Example 1, except that the water content of the undrawn tow was increased by regulating the number of revolutions of the oiling roller and the pressurized air type suction device was removed. Table 1 shows the results of evaluation.

TABLE 1

| | Water | | | | Surface |
|---|---|---|---|---|---|
| | Content | ATMOS- | | Shrinkage | Conditions |
| | of | PHERIC | Elapsed | of | of |
| | Undrawn | Temperature | Time | Undrawn | Undrawn |
| | Tow (%) | (° C.) | (Hours) | Tow (%) | Tow |
| Example 1 | 6 | 30 | 24 | 16 | 3 |
| Example 2 | 6 | 20 | 24 | 12 | 3 |
| Example 3 | 6 | 30 | 48 | 17 | 3 |
| Example 4 | 6 | 30 | 16 | 14 | 3 |
| Example 5 | 4 | 20 | 24 | 12 | 3 |
| Example 6 | 2 | 30 | 24 | 4 | 3 |
| Example 7 | 2 | 20 | 24 | 2 | 3 |
| Comparative | 6 | 40 | 24 | 40 | 1 Sticking |
| Example 1 | | | | | of |
| | | | | | individual |
| | | | | | filaments |
| | | | | | was |
| | | | | | found. |
| Comparative | 0.4 | 30 | 24 | 14 | 1 |
| Example 2 | | | | | Significant |
| | | | | | entangle- |
| | | | | | ment |
| | | | | | of |
| | | | | | individual |
| | | | | | filaments |
| | | | | | was |
| | | | | | found. |
| Comparative | 15 | 30 | 24 | 35 | 2 |
| Example 3 | | | | | Slight |
| | | | | | sticking of |
| | | | | | individual |
| | | | | | filaments |
| | | | | | was |
| | | | | | found. |

Industrial Applicability

According the production method of the present invention, a change in physical properties of an undrawn tow comprising polytrimethylene terephthalate with the lapse of time can be reduced, and polytrimethylene terephthalate staple fibers having uniform quality can be stably produced.

1. A method, for producing polytrimethylene terephthalate staple fibers, characterized in that during the period of time after a polytrimethylene terephthalate polymer is melt-spun and the resultant undrawn tow is taken up through a taking-up roller and placed in a can, but before the undrawn tow stored in the can is subjected to a drawing step, the water content of the undrawn tow is maintained at 0.5 to 12% by mass, and the temperature of the ambient atmosphere surrounding the undrawn tow is maintained at 35° C. or less.

2. The method for producing the polytrimethylene terephthalate staple fibers according to claim 1, wherein the undrawn tow is passed through a suction apparatus using a pressurized air stream, after taking-up the undrawn tow with the take-up roller but before placing the undrawn tow in the can.

3. The method for producing the polytrimethylene terephthalate staple fibers according to claim 1 or 2, wherein the intrinsic viscosity of the polytrimethylene terephthalate polymer is in the range of from 0.5 to 1.8.

4. The method for producing the polytrimethylene terephthalate staple fibers according to any of claims 1 to 3, wherein the melt spinning is carried out at a temperature in the range of from 235 to 285° C.

5. The method for producing the polytrimethylene terephthalate staple fibers according to any of claims 1 to 4, wherein the take-up is carried out at a speed of 500 to 2,000 m/min.
